(19) United States
(12) Patent Application Publication
(10) Pub. No.: US 2023/0280234 A1
(43) Pub. Date: Sep. 7, 2023

(54) LIVE GAS MULTI-SENSING DATA MONITORING SYSTEM

(71) Applicant: Northeast Gas Association, Parsippany, NJ (US)

(72) Inventors: Harold J Kramer, Mendon, NY (US); Travis Downs, Mendon, NY (US)

(21) Appl. No.: 17/942,540

(22) Filed: Sep. 12, 2022

Related U.S. Application Data
(63) Continuation of application No. 15/929,381, filed on Apr. 29, 2020, now abandoned.
(60) Provisional application No. 62/841,631, filed on May 1, 2019.

(51) Int. Cl. G01M 3/40; F17D 5/06

(52) U.S. Cl. CPC G01M 3/40; F17D 5/06

(57) ABSTRACT

A live natural gas system of instruments installed and capable of monitoring and collecting data from locations in a natural gas distribution system without the need to disrupt the flow of natural gas, including a plurality of instruments disposed at locations about a natural gas distribution pipe system, each capable of monitoring one or more of pressure, flow, temperature, humidity and vibration, each including a fluid dynamic sensor such as a pitot tube, capable of being positioned within gas flow within a distribution pipe; communication means for transmitting data collected to a remote location by means of a cellular system; a graphic user interface on which the collected data is displayed with geography information that gives a user the location of the instruments monitoring and collecting data; the instruments capable of being installed in gas-carrying pipes without the need to stop the flow of gas therewithin.

### TECHINCAL FIELD

The present invention teaches a novel system for use with pipes that distribute natural gas, wherein a plurality of instruments can be reliably and safely installed throughout a predetermined portion of piping to permit the monitoring, capturing, and cellular transmission of important data gathered to a remote location where a user is able to evaluate the data and act appropriately.

### BACKGROUND OF THE INVENTION

There exists extensive piping that carries the distribution of natural gas, after the gas leaves the transmission side of its journey. The transmission side carries gas from the ground where it is collected, at relatively high pressures and temperatures, in relatively large diameter pipes, to locations where the raw gas is scrubbed or cleaned before entering the distribution side thereof.

It may come as a surprise to some that utilities whose distribution pipes carry natural gas to its customers have not been fully able to monitor the pressure, temperature, flow, humidity or vibration within a great deal of such piping. A need exists for utilities, for example, to be able to know more about these parameters so that leaks or unwanted pressures may be detected and acted upon, thereby allowing the system to be safer.

Conventional methods and techniques are relatively costly and do not provide the benefits of the present invention. For example, utilities may rely upon individual vendors of specific instruments that may require external power to drive the always-on nature of these instruments. Very few actually incorporate cellular capabilities, where intermediary RF signals are forwarded to other cellular-capable instruments. This places an unwanted financial burden upon utilities.

### SUMMARY OF THE INVENTION

Provided herein is a live natural gas system of instruments installed and capable of monitoring and collecting data from locations in a natural gas distribution system without the need to disrupt the flow of natural gas, including a plurality of instruments disposed at locations about a natural gas distribution pipe system, each capable of monitoring one or more of pressure, flow, temperature, humidity and vibration, each including a fluid dynamic sensor such as a pitot tube, capable of being positioned within gas flow within a distribution pipe; communication means for transmitting data collected to a remote location by means of a cellular system; a graphic user interface on which the collected data is displayed with geography information that gives a user the location of the instruments monitoring and collecting data; the instruments capable of being installed in gas-carrying pipes without the need to stop the flow of gas therewithin.

Before describing the present invention in further detail, the reader is invited to view the accompanying drawings, which visually illustrate a preferred embodiment of the present invention. Other configurations and embodiments are contemplated and will come within the proper and lawful scope of the present invention.

### BRIEF DESCRIPTION OF THE DRAWING

FIG. 1 is an illustration of component parts of the present invention, together with accessories that enable “hot” installation of instruments according to the present invention; and

FIG. 2 graphically depicts elements of the present invention.

### DETAILED DESCRIPTION OF THE INVENTION

As has been stated above, the present invention teaches a novel system for use with pipes that distribute natural gas, wherein a plurality of instruments can be reliably and safely installed throughout a predetermined portion of piping to permit the monitoring, capturing, and cellular transmission of important data gathered to a remote location where a user is able to evaluate the data and act appropriately.

It is contemplated by this invention that hundreds or thousands or tens of thousands of instruments to be known as GASCOMM instruments will be installed in natural gas-carrying piping without interrupting the flow of gas therein. GASCOMM is a trademark owned by the Northeast Gas Association, a not-for-profit organization to which title to and ownership of the present invention is to be assigned.

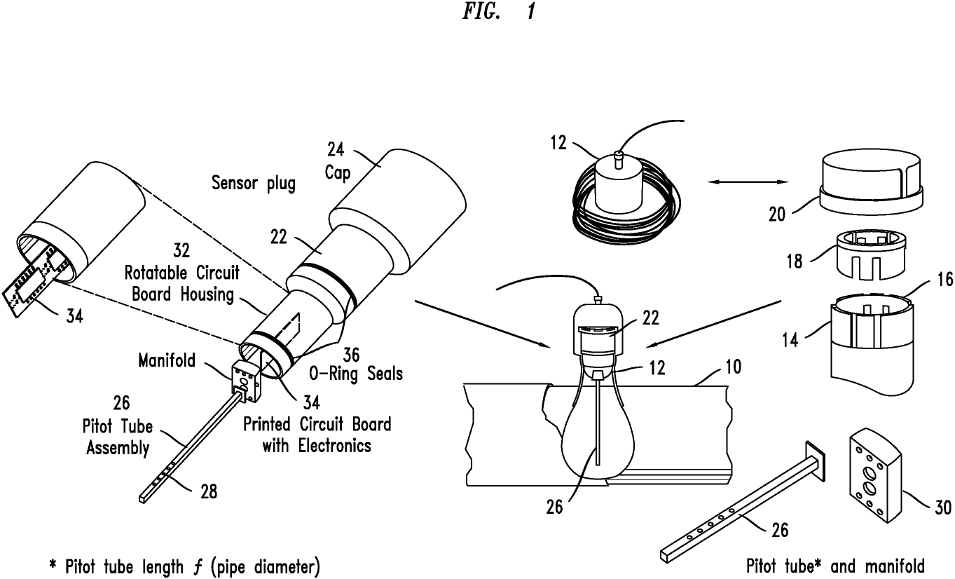

A portion of a typical gas-carrying pipe 10 is depicted in FIG. 1 with a GASCOMM instrument assembly 12 installed therein. It is contemplated that the installation of assembly 12 will be accomplished as follows, although variations of this method are to be considered covered by this invention. An enclosure covers the location of a hole to be drilled through the wall of pipe 10. A nipple 14 shown in FIG. 1 is welded to pipe 10 about the location of said hole. The hole is drilled in a manner that prevents the escape of natural gas from pipe 10. Nipple 14 is formed with internal threads 16 into which a temporary completion plug 18 is tightly screwed, and a cap 20 is threaded onto completion plug 18. The procedure just described has readied the installation of the GASCOMM instrument, at all times preventing the escape of natural gas flowing within pipe 10.

When the instrument assembly 12 according to this invention is ready to be installed, the cap 20 and its associated temporary completion plug 18 are removed from nipple 14 and are replaced by instrument assembly 14, wherein its sensor plug 22 and the elements integral with it is threaded into nipple 14. Instrument assembly 14 includes its own cap 24 which prevents the escape of gas. Upon the installation of instrument assembly 12 into threaded engagement with the threads of nipple 14, a pitot tube 26 or equivalent fluid dynamic sensor is caused to extend approximately fifty percent (50%) of the way into the inside diameter of pipe 10 and into the path of flowing natural gas. Holes 28 formed through diametrically opposite sides of tube 26 permit tube 26 to experience higher pressure at the holes 28 facing impact upstream than those facing downstream. This differential of pressure enables the collection of valuable data from the flowing gas. In this regard, it is important to emphasize that pitot tube 26 is a bi-directional device. This facilitates its being installed at either of 180 degree intended or unintended orientations, whereby software will correct negative readings.

A manifold 30 shown in FIG. 1 is secured to the base of instrument assembly 12 and is formed with threaded openings to which a number of pitot tubes of varying lengths may be secured. This feature facilitates situations where erroneous inside pipe 10 diameter may require replacement of tubes to accommodate pipe 10 inside diameter size.

A rotatable circuit board housing 32 contains therewithin a circuit board 34 carrying predetermined electronics and properties defined by and according to the present invention. O-ring seals 36 prevent the escape of gas when circuit board housing 32 is rotated. This rotation of the housing 32 and its circuit board 34 permit the installer to properly align holes 28 in pitot tube 28 in the direct path of gas flowing within pipe 10.

In a preferred embodiment of this invention, GASCOMM instrument assembly and its components will be constructed of type 304 stainless steel, to resist corrosion and to provide high quality reliable features. While concept of the present invention may be used with polyethylene or equivalent plastic piping, the present patent application does not go into the details thereof.

The GASCOMM instrument assembly is to be powered by long-lasting batteries, as opposed to the supply of power from external sources. In use, any number of instruments 12 are installed throughout a geographical area, and each carries an identification. A user is able to sit at a screen or board which shows the locations of these installed instruments 12. By placing a cursor over a specific instrument location indicated by an LED, for example, the user will be able to identify it and to see data or data summaries that have been supplied by that instrument 12.

To prolong battery life, it is contemplated that installed instruments 12 will sleep for predetermined period of time and will be programmed to awaken periodically at selected times to collect and/or transmit data. In addition, these installed instruments may be programmed to awaken in the event data exceeds or meets predetermined magnitudes or values. For example, if a sleeping instrument’s sensor detects a severe drop in pressure, possibly indicating a leak, the instrument will promptly awaken at this unscheduled time and will alert the user so that the user may take appropriate action. The same may be true if pressures or temperatures are too high. The system of this invention, therefore, may have profound consequences in providing knowledge to a utility about its system. The utility in this way and with the present invention may be able to spot a problem or a potential problem.

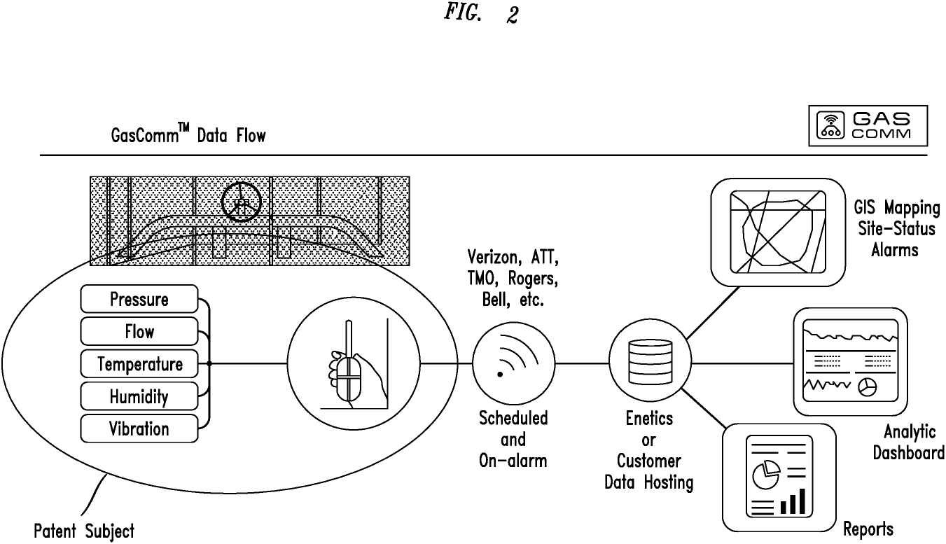

From the foregoing, we thus see that an affordable, territory-wide gas monitoring system is with this invention able to provide reliable data acquisition, telemetry, data warehousing and attractive presentation. With reference to FIG. 2, utilities will be able to accurately monitor real-time performance status of their networks. A system is provided using a relatively small, non-intrusive, stainless steel sensor apparatus intended for permanent installation into live gas distribution steel or plastic piping networks. Enclosed within the assembly a group of micropower integrated circuits are housed and mounted upon a printed circuit board. These enable the monitoring of the magnitude of static pressure, flow velocity, flow volume, termperature, humidity, and 3 axes of acceleration, all as a function of time.

This invention is Class 1, Division 1 intrinsically safe to be able to function in a potentially explosive environment. This system may be powered by batteries, solar, wind, geothermal, AC or DC power. Data may be provided to a communications device that transmits data from the sensor apparatus 12 to a remote (cloud) computer or server device.

A list of the reference characters used herein is as follows:

| | |
|---|---|
| 10 | pipe |
| 12 | GASCOMM instrument assembly |
| 14 | nipple |
| 16 | threads in nipple 14 |
| 18 | temporary completion plug |
| 20 | cap |
| 22 | sensor plug |
| 24 | cap |
| 26 | pitot tube |
| 28 | holes in pitot tube |
| 30 | manifold |
| 32 | rotatable circuit board housing |
| 34 | circuit board |
| 36 | O-ring seals |

What is claimed is:

1. A live natural gas system of instruments installed and capable of monitoring and collecting data from locations in a natural gas distribution system without the need to disrupt the flow of natural gas, comprising, in combination:
a plurality of instruments disposed at locations about a natural gas distribution pipe system, each of said instruments capable of monitoring one or more of pressure, flow, temperature, humidity and vibration,
each of said instruments including a fluid dynamic sensor such as, for example, a pitot tube, capable of being positioned within gas flow within a distribution pipe,
communication means for transmitting data collected to a remote location by means of a cellular system,
a graphic user interface on which said collected data is displayed with geography information that gives a user the location of the instruments monitoring and collecting data,
said instruments capable of being installed in gas-carrying pipes without the need to stop the flow of gas therewithin,
thereby providing the user with data and knowledge about the distribution system to facilitate a safer environment.
